(19) United States
(12) Patent Application Publication
(10) Pub. No.: US 2026/0370360 A1
(43) Pub. Date: Nov. 19, 2026

(54) SYSTEMS AND METHODS FOR EVALUATING A WIRELESS COMMUNICATION PATH

(71) Applicant: Cable Television Laboratories, Inc., Louisville, CO (US)

(72) Inventor: Tucker Polomik, Longmont, CO (US)

(21) Appl. No.: 19/676,542

(22) Filed: May 13, 2026

Related U.S. Application Data
(60) Provisional application No. 63/805,163, filed on May 13, 2025.

(51) Int. Cl. H04B 17/309

(52) U.S. Cl. CPC H04B 17/346

(57) ABSTRACT

A method for evaluating a wireless communication path between a first radio frequency (RF) node and a second RF node includes (i) collecting a plurality of noise measurements over a sample time window from one or more of the first RF node and the second RF node, (ii) determining a representative value of the plurality of noise measurements, (iii) determining a temporal variability value of the plurality of noise measurements, (iv) performing a first comparison by comparing the representative value of the plurality of noise measurements to a predetermined noise threshold value, (v) performing a second comparison by comparing the temporal variability value of the plurality of noise measurements to a predetermined variation threshold value, and (vi) determining a state of the wireless communication path based on each of the first comparison and the second comparison.

### RELATED APPLICATIONS

This application claims benefit of U.S. Provisional Patent Application No. 63/805,163, filed on May 13, 2025, which is incorporated herein by reference.

### BACKGROUND

A wireless communication network transmits signals between radio frequency (RF) nodes using wireless communication signals. A wireless communication path between two RF nodes is ideally non-obstructed so that there is a direct line-of-sight between the two RF nodes. However, wireless communication paths are often obstructed in wireless communication networks. For example, a wireless communication path in a building between an Institute of Electrical and Electronics Engineers (IEEE) 802.11 wireless access point and an IEEE 802.11 station may be obstructed by one or more objects, such as a wall, furniture, etc.

### SUMMARY

Disclosed herein are new systems and methods for evaluating a wireless communication path. Particular embodiments are capable of determining whether a wireless communication path between two RF nodes has any one of the following states: (i) the wireless communication path is subject to a dense RF environment, (ii) the wireless communication path is physically obstructed, (iii) the wireless communication path possesses a clear line-of-sight, and (iv) the wireless communication path is subject to intermittent RF activity. Additionally, certain embodiments can determine state of a wireless communication path solely using noise measurements from one or more RF nodes, e.g., by performing probabilistic analysis on the noise measurements to infer properties of an RF environment affecting a transmitter-receiver pair, thereby promoting compatibility with minimalistic, low-cost RF nodes.

In a first aspect, a method for evaluating a wireless communication path between a first radio frequency (RF) node and a second RF node includes the following steps (i) collecting a plurality of noise measurements over a sample time window from one or more of the first RF node and the second RF node, each noise measurement representing noise of the wireless communication path at a different respective time during the sample time window, (ii) determining a representative value of the plurality of noise measurements, (iii) determining a temporal variability value of the plurality of noise measurements, (iv) performing a first comparison by comparing the representative value of the plurality of noise measurements to a predetermined noise threshold value, (v) performing a second comparison by comparing the temporal variability value of the plurality of noise measurements to a predetermined variation threshold value, and (vi) determining a state of the wireless communication path based on each of the first comparison and the second comparison.

In an embodiment of the first aspect, the representative value of the plurality of noise measurements is a mean of the plurality of noise measurements.

In another embodiment of the first aspect, the temporal variability value of the plurality of noise measurements is a coefficient of variation of the plurality of noise measurements.

In another embodiment of the first aspect, the determined state of the wireless communication path is one of the following: (i) the wireless communication path is subject to a dense RF environment, (ii) the wireless communication path is physically obstructed, (iii) the wireless communication path possesses a clear line-of-sight, and (iv) the wireless communication path is subject to intermittent RF activity.

In another embodiment of the first aspect, determining the state of the wireless communication path based on each of the first comparison and the second comparison comprises determining that the wireless communication path is subject to a dense RF environment in response to (i) the first comparison indicating that the representative value of the plurality of noise measurements is at least the predetermined noise threshold value and (ii) the second comparison indicating that the temporal variability value of the plurality of noise measurements is at least the predetermined variation threshold value.

In another embodiment of the first aspect, the method further includes, in response to determining that the wireless communication path is subject to the dense RF environment, generating a control signal changing one or more of (i) a wireless transmission power of one or more of the first RF node and the second RF node, (ii) a wireless transmission channel of one or more of the first RF node and the second RF node, and (iii) a modulation coding scheme of one or more of the first RF node and the second RF node.

In another embodiment of the first aspect, determining the state of the wireless communication path based on each of the first comparison and the second comparison includes determining that the wireless communication path is physically obstructed in response to (i) the first comparison indicating that the representative value of the plurality of noise measurements is at least the predetermined noise threshold value and (ii) the second comparison indicating that the temporal variability value of the plurality of noise measurements is less than the predetermined variation threshold value.

In another embodiment of the first aspect, the method further includes, in response to determining that the wireless communication path is physically obstructed, generating a control signal for adjusting an antenna orientation of one or more of the first RF node and the second RF node.

In another embodiment of the first aspect, determining the state of the wireless communication path based on each of the first comparison and the second comparison includes determining that the wireless communication path possesses a clear line-of-sight in response to (i) the first comparison indicating that the representative value of the plurality of noise measurements is less than the predetermined noise threshold value and (ii) the second comparison indicating that the temporal variability value of the plurality of noise measurements is less than the predetermined variation threshold value.

In another embodiment of the first aspect, determining the state of the wireless communication path based on each of the first comparison and the second comparison includes determining that the wireless communication path is subject to intermittent RF activity in response to (i) the first comparison indicating that the representative value of the plurality of noise measurements is less than the predetermined noise threshold value and (ii) the second comparison indicating that the temporal variability value of the plurality of noise measurements is at least the predetermined variation threshold value.

In another embodiment of the first aspect, (i) the first RF node is a wireless access point operating according to an Institute of Electrical and Electronics Engineers (IEEE) 802.11 wireless communication protocol, and (ii) the second RF node is a station operating according to an IEEE 802.11 wireless communication protocol.

In another embodiment of the first aspect, the method further includes changing operation of one or more of the first RF node and the second RF node based on the determined state of the wireless communication path.

In a second aspect, a method for evaluating a wireless communication path between a first radio frequency (RF) node and a second RF node includes (1) collecting a plurality of noise measurements over a sample time window from one or more of the first RF node and the second RF node, each noise measurement representing noise of the wireless communication path at a different respective time during the sample time window, (2) determining a representative value of the plurality of noise measurements, (3) determining a temporal variability value of the plurality of noise measurements, and (4) determining, from the representative value of the plurality of noise measurements and the temporal variability value of the plurality of noise measurements, that the wireless communication path is physically obstructed in response to (i) the representative value of the plurality of noise measurements being at least a predetermined noise threshold value and (ii) the temporal variability value of the plurality of noise measurements being less than a predetermined variation threshold value.

In an embodiment of the second aspect, (i) the representative value of the plurality of noise measurements is a mean of the plurality of noise measurements, and (ii) the temporal variability value of the plurality of noise measurements is a coefficient of variation of the plurality of noise measurements.

In another embodiment of the second aspect, (i) the first RF node is a wireless access point operating according to an Institute of Electrical and Electronics Engineers (IEEE) 802.11 wireless communication protocol, and (ii) the second RF node is a station operating according to an IEEE 802.11 wireless communication protocol.

In another embodiment of the second aspect, the method further includes, in response to determining that the wireless communication path is physically obstructed, generating a control signal for adjusting an antenna orientation of one or more of the first RF node and the second RF node.

In a third aspect, a method for evaluating a wireless communication path between a first radio frequency (RF) node and a second RF node includes (1) collecting a plurality of noise measurements over a sample time window from one or more of the first RF node and the second RF node, each noise measurement representing noise of the wireless communication path at a different respective time during the sample time window, (2) determining a representative value of the plurality of noise measurements, (3) determining a temporal variability value of the plurality of noise measurements, and (4) determining, from the representative value of the plurality of noise measurements and the temporal variability value of the plurality of noise measurements, that the wireless communication path is subject to a dense RF environment in response to (i) the representative value of the plurality of noise measurements being at least a predetermined noise threshold value and (ii) the temporal variability value of the plurality of noise measurements being at least a predetermined variation threshold value.

In an embodiment of the third aspect, (i) the representative value of the plurality of noise measurements is a mean of the plurality of noise measurements, and (ii) the temporal variability value of the plurality of noise measurements is a coefficient of variation of the plurality of noise measurements.

In another embodiment of the third aspect, (i) the first RF node is a wireless access point operating according to an Institute of Electrical and Electronics Engineers (IEEE) 802.11 wireless communication protocol, and (ii) the second RF node is a station operating according to an IEEE 802.11 wireless communication protocol.

In another embodiment of the third aspect, the method further includes, in response to determining that the wireless communication path is subject to the dense RF environment, generating a control signal changing one or more of (i) a wireless transmission power of one or more of the first RF node and the second RF node, (ii) a wireless transmission channel of one or more of the first RF node and the second RF node, and (iii) a modulation coding scheme of one or more of the first RF node and the second RF node.

In a fourth aspect, a method for evaluating a wireless communication path between a first radio frequency (RF) node and a second RF node includes (1) collecting a plurality of noise measurements over a sample time window from one or more of the first RF node and the second RF node, each noise measurement representing noise of the wireless communication path at a different respective time during the sample time window, (2) determining a representative value of the plurality of noise measurements, (3) determining a temporal variability value of the plurality of noise measurements, and (4) determining, from the representative value of the plurality of noise measurements and the temporal variability value of the plurality of noise measurements, that the wireless communication path is subject to intermittent RF activity in response to (i) the representative value of the plurality of noise measurements being less than a predetermined noise threshold value and (ii) the temporal variability value of the plurality of noise measurements being greater than a predetermined variation threshold value.

In an embodiment of the fourth aspect, (i) the representative value of the plurality of noise measurements is a mean of the plurality of noise measurements, and (ii) the temporal variability value of the plurality of noise measurements is a coefficient of variation of the plurality of noise measurements.

In another embodiment of the fourth aspect, (i) the first RF node is a wireless access point operating according to an Institute of Electrical and Electronics Engineers (IEEE) 802.11 wireless communication protocol, and (ii) the second RF node is a station operating according to an IEEE 802.11 wireless communication protocol.

In a fifth aspect, a method for evaluating a wireless communication path between a first radio frequency (RF) node and a second RF node includes (1) collecting a plurality of noise measurements over a sample time window from one or more of the first RF node and the second RF node, each noise measurement representing noise of the wireless communication path at a different respective time during the sample time window, (2) determining a representative value of the plurality of noise measurements, (3) determining a temporal variability value of the plurality of noise measurements, and (4) determining, from the representative value of the plurality of noise measurements and the temporal variability value of the plurality of noise measurements, that the wireless communication path possesses a clear line-of-sight in response to (i) the representative value of the plurality of noise measurements being less than a predetermined noise threshold value and (ii) the temporal variability value of the plurality of noise measurements being less than a predetermined variation threshold value.

In an embodiment of the fifth aspect, (i) the representative value of the plurality of noise measurements is a mean of the plurality of noise measurements, and (ii) the temporal variability value of the plurality of noise measurements is a coefficient of variation of the plurality of noise measurements.

In another embodiment of the fifth aspect, (i) the first RF node is a wireless access point operating according to an Institute of Electrical and Electronics Engineers (IEEE) 802.11 wireless communication protocol, and (ii) the second RF node is a station operating according to an IEEE 802.11 wireless communication protocol.

### BRIEF DESCRIPTION OF THE DRAWINGS

FIG. 1 is a schematic diagram of a communication environment including an evaluation system.

FIG. 2 is a schematic diagram of an embodiment of the FIG. 1 communication environment where radio frequency (RF) nodes are implemented by Institute of Electrical and Electronics Engineers (IEEE) 802.11 devices.

FIG. 3 is a schematic diagram of an embodiment of the FIG. 1 communication environment where RF nodes are implemented by satellite wireless communication devices.

FIG. 4 is a schematic diagram of an embodiment of the FIG. 1 communication environment where RF nodes are implemented by Zigbee wireless communication devices.

FIG. 5 is a block diagram of one embodiment of the evaluation system of FIG. 1 including a processing subsystem and an information store.

FIG. 6 is a data flow diagram illustrating one example of operation of the FIG. 5 evaluation system.

FIG. 7 is a schematic diagram of an embodiment of the FIG. 1 communication environment further including additional RF sources that subject a wireless communication path to a dense RF environment.

FIG. 8 is a schematic diagram of an embodiment of the FIG. 1 communication environment further including an object obstructing a wireless communication path.

FIG. 9 is a schematic diagram of an embodiment of the FIG. 1 communication environment further including a microwave oven that subjects a wireless communication path to intermittent RF activity.

FIG. 10 is an illustration of one embodiment of a decision matrix of the FIG. 5 evaluation system.

### DETAILED DESCRIPTION OF THE EMBODIMENTS

There is significant value in determining the state of a wireless communication path between two radio frequency (RF) nodes, such as a wireless communication path between two Institute of Electrical and Electronics Engineers (IEEE) 802.11 devices. For example, consider a scenario where an Internet Service Provider (ISP) has deployed a gateway at a customer's premises to support a wireless communication network, where the gateway includes an IEEE 802.11 wireless access point (AP). The IEEE 802.11 wireless access point may serve one or more wireless clients in the form of IEEE 802.11 stations. Additionally, assume that the customer reports poor performance of the wireless communication network. It would be helpful if the ISP could remotely evaluate wireless communication paths between the wireless AP and the one or more stations, to enable the ISP to remotely diagnose why the customer is experiencing poor wireless communication network performance. For example, assume that an object blocks a wireless communication path between the wireless AP and a station. It would be helpful if the ISP could remotely determine presence of the object from data generated by the wireless AP and/or from data generated by the station, to enable the ISP to determine the cause of the poor performance without requiring the ISP to visit the customer's premises.

Conventional methods of evaluating a wireless communication path between IEEE 802.11 devices rely on Relative Signal Strength (RSSI) measurements. RSSI is typically parameterized by physical distance, such as according to equation (1) below, where P_{T} is transmission power, P_{L} is a path loss function, ais a path loss exponent, X_{σ} is a Gaussian random variable with μ=0, dₒ is a reference distance (e.g., one meter), and dis a distance between the two IEEE 802.11 devices.

$$RSSI ( d ) = {P}_{T} - {P}_{L} ( {d}_{0} ) - 10 α log ( \frac{d}{{d}_{0}} ) + {X}_{σ} \qquad ( 1 )$$

RSSI alone cannot reliably distinguish between signal degradation caused by physical distance, RF interference, or attenuation from physical obstructions. In particular, RSSI alone cannot indicate whether a loss in signal is due to a factor other than separation distance, such as due to a path obstruction or interference, because RSSI is primarily a function of physical distance. Accordingly, in RF systems having insight into their physical surroundings only from physical-layer measurements (as is the case with most home IEEE 802.11 wireless access points), RSSI alone does not serve as a sufficient vector for deducing a wireless access point's physical location relative to clients that it serves.

Disclosed herein are new systems and methods for evaluating a wireless communication path which at least partially overcome the above-discussed drawbacks of conventional methods for evaluating a wireless communication path. Particular embodiments are capable of determining whether a wireless communication path between two RF nodes has any one of the following states: (i) the wireless communication path is subject to a dense RF environment, (ii) the wireless communication path is physically obstructed, (iii) the wireless communication path possesses a clear line-of-sight, and (iv) the wireless communication path is subject to intermittent RF activity. As such, the new systems and methods can obtain significantly more information on a wireless communication path than can be realized using traditional RSSI techniques. Additionally, certain embodiments can determine state of a wireless communication path solely using noise measurements from one or more RF nodes, e.g., by performing probabilistic analysis on the noise measurements to infer properties of an RF environment affecting a transmitter-receiver pair, thereby promoting compatibility with minimalistic, low-cost RF nodes.

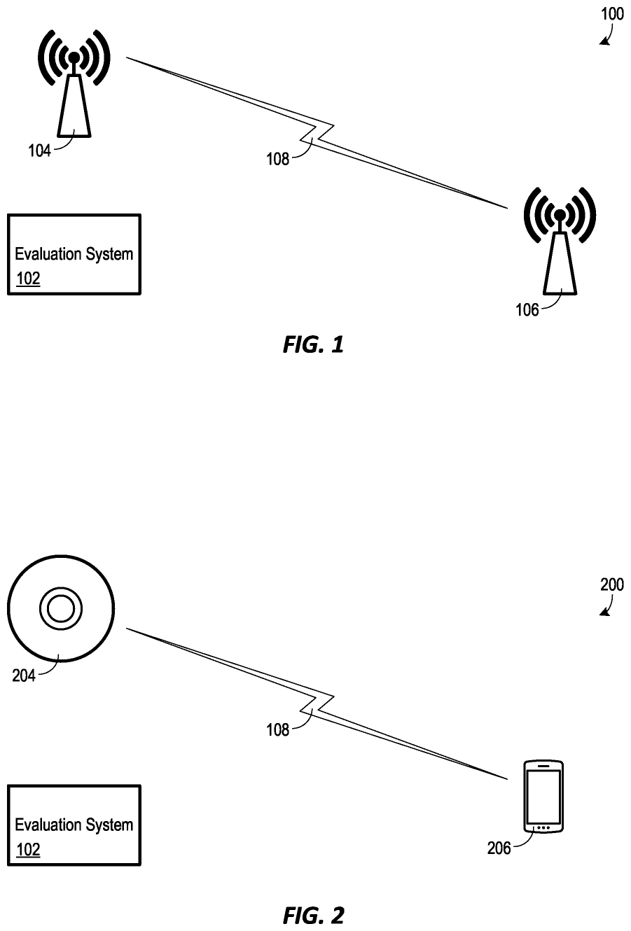

FIG. 1 is a schematic diagram of a communication environment 100 including an evaluation system 102, where evaluation system 102 is one embodiment of the new systems for evaluating a wireless communication path. Communication environment 100 further includes a first RF node 104 and a second RF node 106, where first RF node 104 and second RF node 106 are configured to wirelessly communicate with each other in point-to-point communication via a wireless communication path 108, i.e. by sending wireless communication signals between each other via wireless communication path 108. First RF node 104 and second RF node 106 could be capable of two-way point-to-point communication via wireless communication path 108, or first RF node 104 and second RF node 106 could be configured for only one-way point-to-point communication via wireless communication path 108. While FIG. 1 illustrates wireless communication path 108 as possessing a clear line-of-sight between first RF node 104 and second RF node 106, wireless communication path 108 may alternately be subject to RF interference and/or be physically obstructed, as discussed below. Communication environment 100 could include additional elements, e.g., one or more additional RF nodes, one or more wireline communication links, and/or one or more core networks, without departing from the scope hereof.

First RF node 104 and second RF node 106 can be essentially any type of RF node capable of wireless communication with each other via wireless communication path 108. By way of example and not limitation, first RF node 104 and second RF node 106 could operate according to any one or more of the following wireless communication protocols: (i) an IEEE 802.11 wireless communication protocol, e.g., a Wi-Fi wireless communication protocol, (ii) a Bluetooth wireless communication protocol, (iii) a long range (LoRa) wireless communication protocol, (iv) a Zigbee wireless communication protocol, (v) a Z-Wave wireless communication protocol, (vi) a Third Generation Partnership Project (3GG) wireless communication protocol, e.g., a long term evolution (LTE) wireless communication protocol, a fifth generation (5G) wireless communication protocol, or a sixth generation (6G) wireless communication protocol, and (vii) a satellite wireless communication protocol. Discussed below with respect to FIGS. 2-4 are several example implementations of first RF node 104 and second RF node 106. It is understood, though, that first RF node 104 and second RF node 106 are not limited to the example embodiments of FIGS. 2-4.

FIG. 2 is a schematic diagram of a communication environment 200 which is an embodiment of communication environment 100 where (i) first RF node 104 is implemented by an IEEE 802.11 wireless AP 204 and (ii) second RF node 106 is implemented by an IEEE 802.11 station 206. Although station 206 is depicted as being an IEEE 802.11-enabled mobile phone, station 206 could be another type of IEEE 802.11-enabled device, including but not limited to a computer, a set-top box, an entertainment device, a security device, a medical device, a wearable device, a data storage device, or an Internet of Things (IoT) device. In particular embodiments, wireless AP 204 and station 206 operate according to one or more Wi-Fi wireless communication protocols, such as a Wi-Fi 5 (IEEE 802.11ac) wireless communication protocol, a Wi-Fi 6 (IEEE 802.11ax) wireless communication protocol, a Wi-Fi 7 (IEEE 802.11be) wireless communication protocol, and a successor or extension of any of the foregoing Wi-Fi wireless communication protocols.

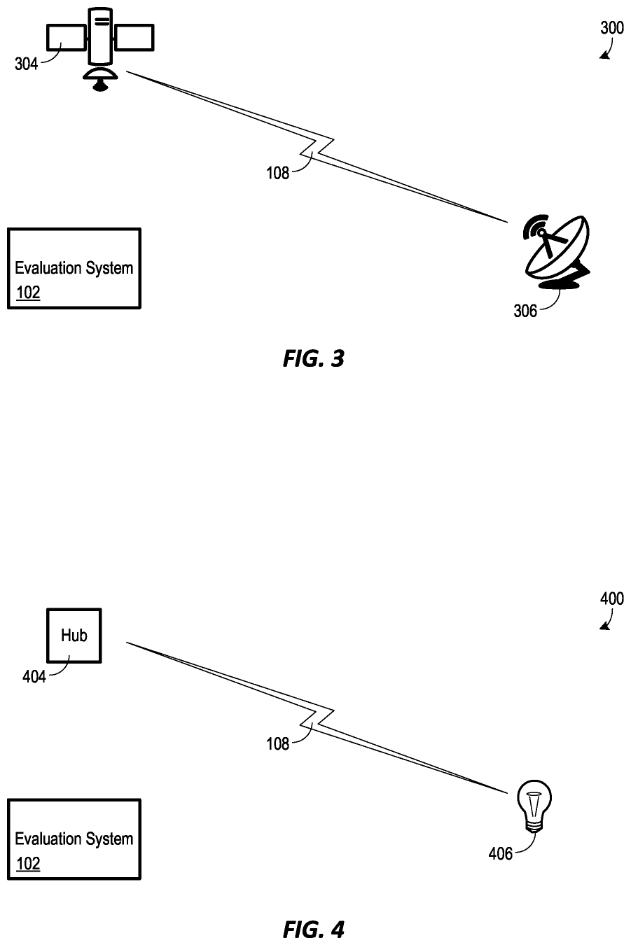

FIG. 3 is a schematic diagram of a communication environment 300 which is an embodiment of communication environment 100 where (i) first RF node 104 is implemented by a satellite 304 and (ii) second RF node 106 is implemented by a satellite ground station 306. In some embodiments, satellite 304 is one of a very low earth orbit (VLEO) satellite, a low earth orbit (LEO) satellite, a medium earth orbit (MEO) satellite, and a geostationary equatorial orbit (GEO) satellite. In certain embodiments, satellite 304 and satellite ground station 306 operate according to a satellite wireless communication protocol or a non-terrestrial version of a 3GPP wireless communication protocol, e.g., 5G NR-NTN or a successor thereof.

FIG. 4 is a schematic diagram of a communication environment 400 that is an embodiment of communication environment 100 where (i) first RF node 104 is implemented by a Zigbee hub 404 and (ii) second RF node 106 is implemented by a Zigbee-implemented smart light bulb 406. It is understood, though, that smart light bulb 406 could be replaced with another Zigbee-implemented device, such as a security device or an IoT device. In particular embodiments, hub 404 and smart light bulb 406 operate according to a communication protocol based on an IEEE 802.15.4 standard.

Referring again to FIG. 1, evaluation system 102 is configured to (i) receive noise measurements from one or more of first RF node 104 and second RF node 106 and (ii) determine a state of wireless communication path 108 based on the received noise measurements, as discussed below. Although evaluation system 102 is depicted as being a discrete element, evaluation system 102 could be partially or fully combined with one or more other elements. For example, evaluation system 102 could be integrated with first RF node 104, second RF node 106, or another device, e.g., a network gateway, in the vicinity of first RF node 104 and/or second RF node 106. As another example, evaluation system 102 could be integrated with a network controller. Additionally, evaluation system 102 could be remote from first RF node 104 and second RF node 106. For example, evaluation system 102 could be implemented in infrastructure of an ISP, such as in a headend, a central office, or an analogous facility. As another example, evaluation system 102 could be implemented in a distributed computing environment, such as in a cloud computing environment.

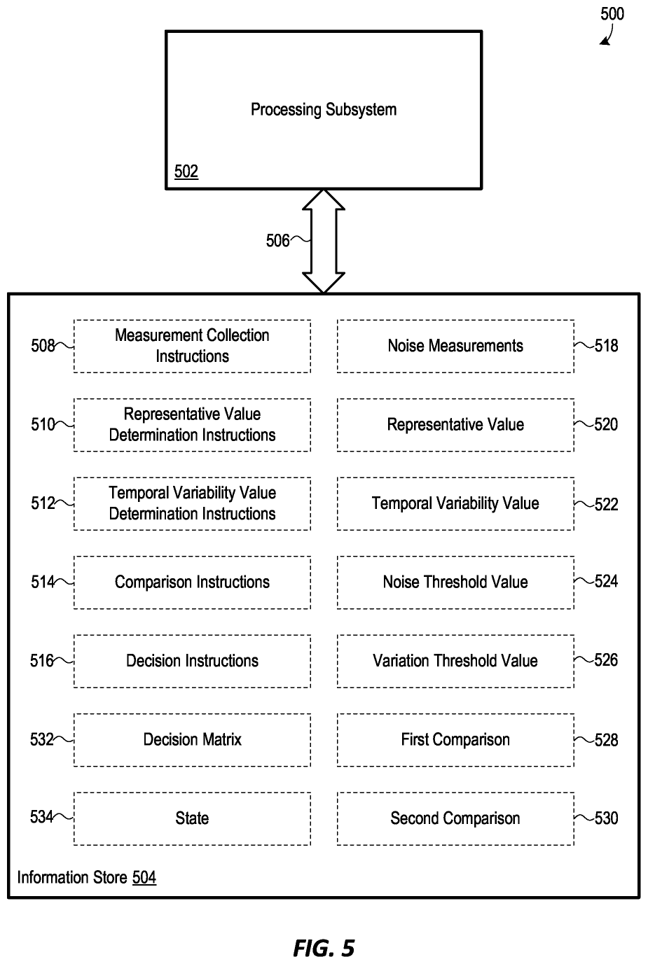

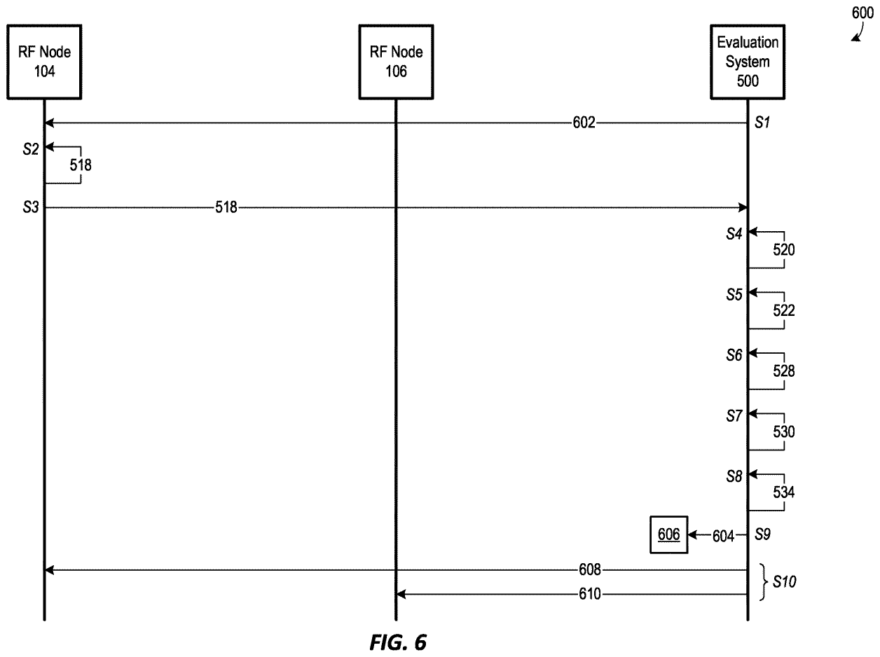

In some embodiments, evaluation system 102 is implemented by analog and/or digital electronic circuitry. Additionally, in some embodiments, evaluation system 102 is at least partially implemented by one or more processors executing instructions, such as instructions in the form of software and/or firmware, to perform the functions of evaluation system 102. For example, FIG. 5 is a block diagram of an evaluation system 500, where evaluation system 500 is one possible embodiment of evaluation system 102. However, evaluation system 102 could be embodied in other manners as long as evaluation system 102 is configured to perform functions similar to those of evaluation system 500.

Evaluation system 500 includes a processing subsystem 502 and an information store 504, where processing subsystem 502 is communicatively coupled to information store 504 as symbolically shown by an arrow 506. Processing subsystem 502 includes one or more processors, and information store 504 includes one or more elements that are capable of storing information and are readable by processing subsystem 502. For example, processing subsystem 502 may include one or more hard drives, one or more memories, one or more data storage structures, etc. The elements of evaluation system 500 need not be co-located. For example, in some embodiments, evaluation system 500 is implemented in a distributed computing environment, such as in a cloud computing environment. Information store 504 is depicted as storing the following instructions, which are, for example, instructions in the form of software or firmware: (i) measurement collection instructions 508, (ii) representative value determination instructions 510, (iii) temporal variability value determination instructions 512, (iv) comparison instructions 514, and (v) decision instructions 516. Information store 504 is also depicted as storing the following data: (i) noise measurements 518, (ii) a representative value 520, (iii) a temporal variability value 522, (iv) a noise threshold value 524, (v) a variation threshold value 526, (vi) a first comparison 528, (vii) a second comparison 530, (viii) a decision matrix 532, and (ix) a state 534. However, it is understood that the instructions and data stored in information store 504 could vary as long as evaluation system 500 can perform functions similar to those discussed herein.

FIG. 6 is a data flow diagram 600 illustrating an example of operation of evaluation system 500. However, it is understood that evaluation system 500 is not limited to operating according to data flow diagram 600. For example, some steps of data flow diagram 600 could be executed in a different order than that illustrated in data flow diagram 600. As another example, some steps of data flow diagram 600 could be executed in parallel instead of in series. Data flow diagram 600 includes a respective vertical line logically representing each of first RF node 104, second RF node 106, and evaluation system 500.

Referring again to FIG. 5, processing subsystem 502 executes measurement collection instructions 508 to collect a plurality of noise measurements 518 over a sample time window from one or more of first RF node 104 and second RF node 106, where each noise measurement 518 represents noise of wireless communication path 108 at a different respective time during the sample time window. For example, processing subsystem 502 may execute measurement collection instructions 508 to send a measurement request 602 to first RF node 104, as illustrated in a step S1 of data flow diagram 600. First RF node 104 may respond to measurement request 602 in a step S2 of data flow diagram 600 by collecting noise measurements 518 of wireless communication path 108 over a measurement time window, and first RF node 104 may send the collected noise measurements 518 to evaluation system 500 in a step S3 of data flow diagram 600. First RF node 104 collects noise measurements 518, for example, by performing physical (PHY)-layer noise floor estimates, channel idle power measurements, spectral scans, and/or other radio-reported noise measurements available from a wireless chipset of first RF node 104. Alternately or additionally, evaluation system 500 could collect noise measurements 518 from second RF node 106 via a procedure analogous to that of steps S1 through S3 of data flow diagram 600.

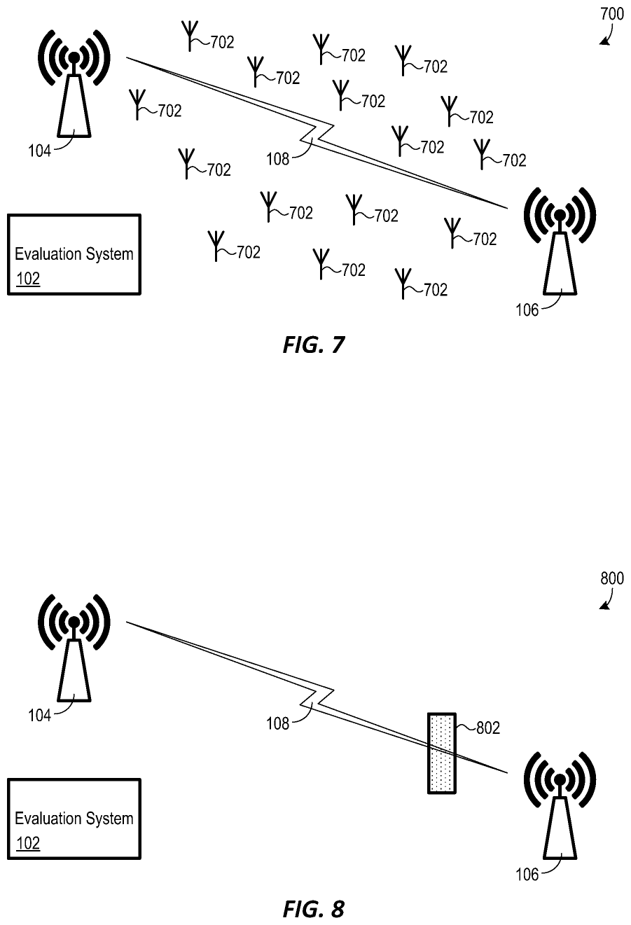

Noise of wireless communication path 108 is RF energy detected by first RF node 104 or second RF node 106 that cannot be used to recover information represented by a wireless communication signal transmitted between first RF node 104 and second RF node 106 via wireless communication path 108. Noise of wireless communication path 108 may degrade wireless communication between first RF node 104 and second RF node 106, such as by reducing a signal to noise ratio of a wireless communication signal transmitted between first RF node 104 and second RF node 106. Noise of wireless communication path 108 may result from wireless communication path 108 being subject to a dense RF environment, such as in cases where there are many RF nodes, in addition to first RF node 104 and second RF node 106, in the vicinity of wireless communication path 108. For example, FIG. 7 is a schematic diagram of a wireless communication environment 700, which is an embodiment of communication environment 100 further including additional RF sources 702. Additional RF sources 702 represent, for example, user devices and/or wireless APs in the vicinity of first RF node 104 and second RF node 106, such as at a location with many people, e.g., at a concert venue, a sporting event stadium, an airport terminal, etc. Additional RF sources 702 subject wireless communication path 108 to a dense RF environment by generating a large amount of RF energy on the same wireless communication channel being used by first RF node 104 and second RF node 106, or on a wireless communication channel overlapping with the wireless communication channel used by first RF node 104 and second RF node 106. RF energy generated by additional RF sources 702 is considered noise to first RF node 104 and second RF node 106, and this RF energy therefore potentially interferes with wireless communication between first RF node 104 and second RF node 106.

Noise of wireless communication path 108 may also result from physical obstruction of wireless communication path 108. For example, FIG. 8 is a schematic diagram of a wireless communication environment 800, which is an embodiment of communication environment 100 further including a physical obstruction 802 in wireless communication path 108. Physical obstruction 802 is at least partially RF opaque. Consequently, physical obstruction 802 at least partially impedes transmission of wireless communication signals traveling along wireless communication path 108, thereby creating noise and interfering with wireless communication between first RF node 104 and second RF node 106.

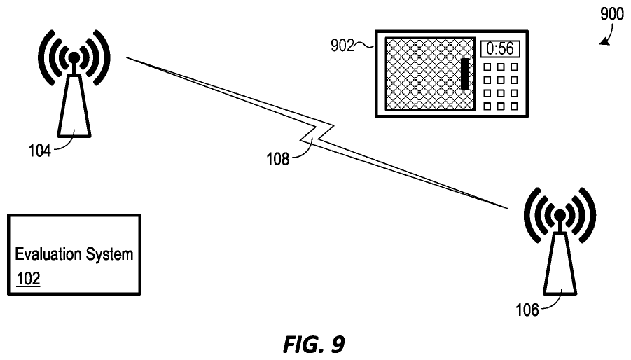

Noise of wireless communication path 108 may additionally result from intermittent RF activity in the vicinity of wireless communication path 108, such as due to radar pulses affecting a Wi-Fi dynamic frequency selection (DFS) channel, intermittent operation of a nearby microwave oven, or occasional wireless transmission from a nearby Bluetooth device. For example, FIG. 9 is a schematic diagram of a wireless communication environment 900, which is an embodiment of communication environment 100 further including a microwave oven 902 in the vicinity of wireless communication path 108. Microwave oven 902 generates RF energy only when it is operating, e.g., when it is heating food, and microwave oven 902 is therefore an intermittent RF source. RF energy generated by microwave oven 902 is considered noise to first RF node 104 and second RF node 106, and RF energy generated by microwave oven 902 potentially interferes with wireless communication between first RF node 104 and second RF node 106. Accordingly, a noise floor of wireless communication path 108 is generally low in wireless communication environment 900, but microwave oven 902 causes wireless communication path 108 to be subject to significant interference from time to time.

Referring again to FIGS. 5 and 6, processing subsystem 502 executes representative value determination instructions 510 to determine a representative value 520 of noise measurements 518, as illustrated in a step S4 of data flow diagram 600. Representative value 520 refers to a statistical value representative of the plurality of noise measurements 518, such as a mean or median of noise measurements 518. In some embodiments, processing subsystem 502 executes representative value determination instructions 510 to solve equation (2) below to determine representative value 520 in the form of a mean μ of noise measurements 518, where N is a quantity of noise measurements 518 in the sample window, noiseᵢ is a noise measurement 518 having an index i, and [symbol] is the set of all N noise measurements 518.

$$μ = \frac{{\sum }_{i = 1}^{N} {noise}_{i}}{N} , {noise}_{i} ∈ ℜ \qquad ( 2 )$$

Processing subsystem 502 additionally executes temporal variability value determination instructions 512 to determine temporal variability value 522 of noise measurements 518 as illustrated in a step S5 of data flow diagram 600, where temporal variability value 522 represents variation, e.g., spread, among noise measurements 518. For example, in certain embodiments, temporal variability value 522 is a coefficient of variation CV of noise measurements 518, where coefficient of variation CV measures the dispersion of a probability or frequency distribution of noise measurements 518. Accordingly, in certain embodiments, processing subsystem 502 executes temporal variability value determination instructions 512 to solve equations (3) and (4) below to determine CV, where V is variance of noise measurements 518, μ is the mean of noise measurements 518 as determined using equation (2) above, and Nand noiseᵢ are as discussed above with respect to equation (2).

$$V = \frac{1}{N - 1} {\sum }_{i = 1}^{N} {( {noise}_{i} - μ )}^{2} \qquad ( 3 )$$

$$CV = \frac{\sqrt{V}}{μ} \qquad ( 4 )$$

After evaluation system 500 determines representative value 520, processing subsystem 502 executes comparison instructions 514 to perform first comparison 528 by comparing representative value 520 to noise threshold value 524, as illustrated in step S6 of data flow diagram 600, such as by determining whether representative value 520 is (i) greater than noise threshold value 524, (ii) less than noise threshold value 524, or (iii) equal to noise threshold value 524. As such, in certain embodiments, first comparison 528 indicates whether representative value 520 is greater than, less than, or equal to, noise threshold value 524. Noise threshold value 524 is a predetermined value that represents a threshold where representative value 520 is considered to indicate significant noise on wireless communication path 108. Stated differently, noise threshold value 524 is a threshold between environments of wireless communication path 108 with high noise and environments of wireless communication path 108 with low noise. Some embodiments of evaluation system 500 determine noise threshold value 524 from baseline noise measurements from first RF node 104 and/or second RF node 106 during commissioning of these RF nodes or shortly after deployment of these RF nodes.

Analogously, after evaluation system 500 determines temporal variability value 522, processing subsystem 502 executes comparison instructions 514 to perform second comparison 530 by comparing temporal variability value 522 to variation threshold value 526, as illustrated in a step S7 of data flow diagram 600, such as by determining whether temporal variability value 522 is (i) greater than variation threshold value 526, (ii) less than variation threshold value 526, or (iii) equal to variation threshold value 526. As such, in certain embodiments, second comparison 530 indicates whether temporal variability value 522 is greater than, less than, or equal to, variation threshold value 526. Variation threshold value 526 is a predetermined value that represents a threshold where temporal variability value 522 is considered to indicate significant temporal variation in noise on wireless communication path 108. Stated differently, variation threshold value 526 represents a threshold between environments of wireless communication path 108 with high noise variability and environments of wireless communication path 108 with low noise variability. Some embodiments of evaluation system 500 determine variation threshold value 526 based on baseline noise measurements from first RF node 104 and/or second RF node 106 during commissioning of these RF nodes or shortly after deployment of these RF nodes.

Processing subsystem 502 executes decision instructions 516 to determine state 534 based on each of first comparison 528 and second comparison 530, as illustrated in a step S8 of data flow diagram 600. State 534 is state of wireless communication path 108, and state 534 may be any one of the following states: (i) wireless communication path 108 is subject to a dense RF environment, e.g., as illustrated in FIG. 7, (ii) wireless communication path 108 is physically obstructed, e.g., as illustrated in FIG. 8, (iii) wireless communication path 108 possesses a clear line-of-sight, e.g., as illustrated in FIG. 1, and (iv) wireless communication path 108 is subject to intermittent RF activity, e.g., as illustrated in FIG. 9. In certain embodiments, decision instructions 516 instruct evaluation system 500 to consult decision matrix 532 when determining state 534, where decision matrix 532 indicates state 534 as a function of first comparison 528 and second comparison 530.

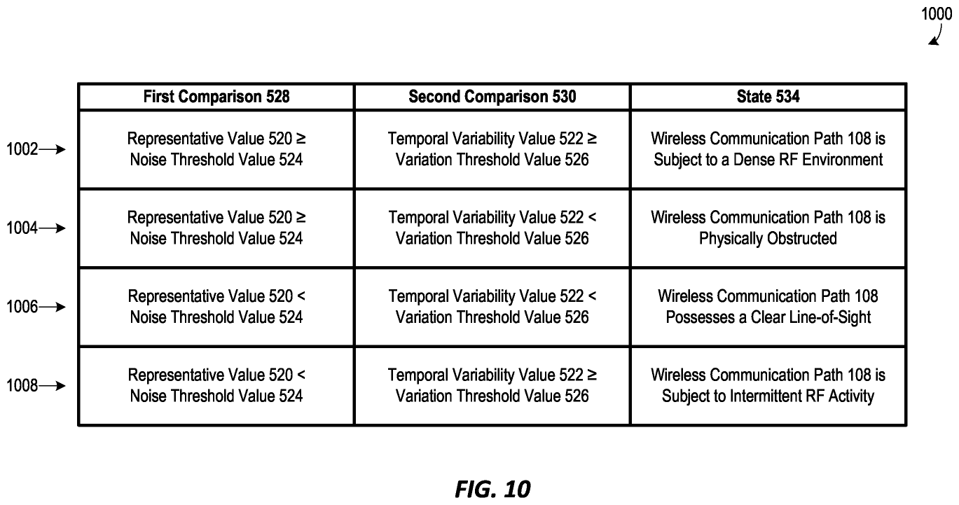

For example, FIG. 10 illustrates a decision matrix 1000, where decision matrix is one embodiment of decision matrix 532. Decision matrix 1000 includes three columns, i.e., a column for first comparison 528, a column for second comparison 530, and a column for state 534. Decision matrix 1000 additionally includes rows 1002, 1004, 1006, and 1008 collectively associating four different combinations of first comparison 528 and second comparison 530 with respective states 534. Row 1002 corresponds to (i) representative value 520 being greater than or equal to noise threshold value 524 and (ii) temporal variability value 522 being greater than or equal to variation threshold value 526. Applicant has found that this combination of comparison values 528 and 530 indicates that wireless communication path 108 is subject to a dense RF environment with same-channel or co-channel interference, e.g., as illustrated in FIG. 7. Therefore, row 1002 associates the combination of (i) representative value 520 being greater or than equal to noise threshold value 524 and (ii) temporal variability value 522 being greater than or equal to variation threshold value 526 with wireless communication path 108 having a state of being subject to a dense RF environment. Accordingly, in particular embodiments, processing subsystem 502 executes decision instructions 516 to determine that wireless communication path 108 is subject to a dense RF environment in response to (i) first comparison 528 indicating that representative value 520 is greater than or equal to noise threshold value 524 and (ii) second comparison 530 indicating that temporal variability value 522 is greater than or equal to variation threshold value 526.

Row 1004 corresponds to (i) representative value 520 being greater than or equal to noise threshold value 524 and (ii) temporal variability value 522 being less than variation threshold value 526. Applicant has found that this combination of comparison values 528 and 530 indicates that wireless communication path 108 is physically obstructed by a static obstruction, e.g., as illustrated in FIG. 8, that causes attenuation of a desired communication signal between first RF node 104 and second RF node 106 while leaving background noise relatively constant. Therefore, row 1004 associates the combination of (i) representative value 520 being greater than or equal to noise threshold value 524 and (ii) temporal variability value 522 being less than variation threshold value 526 with wireless communication path 108 having a state of being physically obstructed. Accordingly, in particular embodiments, processing subsystem 502 executes decision instructions 516 to determine that wireless communication path 108 is physically obstructed in response to (i) first comparison 528 indicating that representative value 520 is greater than or equal to noise threshold value 524 and (ii) second comparison 530 indicating that temporal variability value 522 is less than variation threshold value 526.

Row 1006 corresponds to (i) representative value 520 being less than noise threshold value 524 and (ii) temporal variability value 522 being less than variation threshold value 526. Applicant has found that this combination of comparison values 528 and 530 indicates that wireless communication path 108 possesses a clear line-of-sight, e.g., as illustrated in FIG. 1. Therefore, row 1006 associates the combination of (i) representative value 520 being less than noise threshold value 524 and (ii) temporal variability value 522 being less than variation threshold value 526 with wireless communication path 108 having a state of possessing a clear line-of-sight. Accordingly, in particular embodiments, processing subsystem 502 executes decision instructions 516 to determine that wireless communication path 108 possesses a clear line-of-sight in response to (i) first comparison 528 indicating that representative value 520 is less than noise threshold value 524 and (ii) second comparison 530 indicating that temporal variability value 522 is less than variation threshold value 526.

Row 1008 corresponds to (i) representative value 520 being less than noise threshold value 524 and (ii) temporal variability value 522 being greater than or equal to variation threshold value 526. Applicant has found that this combination of comparison values 528 and 530 indicates that wireless communication path 108 is subject to intermittent RF activity, e.g., as illustrated in FIG. 9. Therefore, row 1008 associates the combination of (i) representative value 520 being less than noise threshold value 524 and (ii) temporal variability value 522 being greater than or equal to variation threshold value 526 with wireless communication path 108 having a state of being subject to intermittent RF activity. Accordingly, in particular embodiments, processing subsystem 502 executes decision instructions 516 to determine that wireless communication path 108 is subject to intermittent RF activity in response to (i) first comparison 528 indicating that representative value 520 is less than noise threshold value 524 and (ii) second comparison 530 indicating that temporal variability value 522 is greater than or equal to variation threshold value 526.

After evaluation system 500 completes step S8 of data flow diagram 600, evaluation system 500 optionally sends a signal 604 to an external entity 606 indicating determined state 534 of wireless communication path 108, as illustrated in a step S9 of data flow diagram 600, to advise external entity 606 of the state 534 of wireless communication path 108. External entity 606 is, for example, a device or a system of an ISP, and the ISP may use signal 604 to remotely troubleshoot poor performance of communication environment 100. As another example, external entity 606 could be a device or system associated with a user of communication environment 100, and the user may use signal 604 the troubleshoot poor performance of communication environment 100. Alternately, evaluation system 500 could send signal 604 to first RF node 104 and/or second RF node 106.

Additionally, evaluation system 500 optionally sends a control signal 608 to first RF node 104 and/or a control signal 610 to second RF node 106, as illustrated in a step S10 of data flow diagram 600, after completing step S8 of data flow diagram 600. Control signal 608 and control signal 610 command first RF node 104 and second RF node 106, respectively, to change operation in response to determined state 534 of wireless communication path 108, such as to change an antenna orientation, a wireless transmission power, a wireless transmission channel, a modulation coding scheme, etc. For example, in certain embodiments, evaluation system 500 generates control signal 608 instructing first RF node 104 to adjust an orientation of its antenna in response to wireless communication path 108 being physically obstructed, to attempt to mitigate the physical obstruction by changing a location of wireless communication path 108. As another example, in certain embodiments, evaluation system 500 generates control signal 608 instructing first RF node 104 to change its wireless transmission power, its wireless transmission channel, and/or its modulation coding scheme, in response to wireless communication path 108 being subject to a dense RF environment or intermittent RF activity, to attempt to mitigate effects of the dense RF environment or the intermittent RF activity on wireless communication path 108. For instance, control signal 608 could instruct first RF node 104 to increase its transmission power and thereby increase a signal to noise ratio of a wireless communication signal, to help compensate for a dense RF environment or intermittent RF activity. As another example, control signal 608 could instruct first RF node 104 to switch its transmission channel to a channel that is relatively free of interference, to help compensate for a dense RF environment or intermittent RF activity. As an additional example, control signal 608 could instruct first RF node 104 to change its modulation coding scheme to a lower order modulation coding scheme that is more robust than a current modulation coding scheme, to help compensate for a dense RF environment or intermittent RF activity.

The following are a few example applications of the new evaluation systems disclosed herein. However, it is understood that the new evaluation systems are not limited to these example applications. Additionally, the new evaluation systems need not necessarily be capable of supporting the following example applications.

### Example A—Network Operator Support Diagnostics

An ISP may use certain embodiments of evaluation system 500 to diagnose poor wireless communication network signal strength reported by a customer. For example, the ISP may use state 534 information received via signal 604 to determine whether the reported poor signal strength is a result of the wireless communication network being subject to a dense RF environment, the wireless communication network being subject to intermittent RF activity, or the wireless communication network being physically obstructed. The ISP may then recommend an appropriate solution to the customer, such as repositioning a wireless access point of the wireless communication network if state 534 indicates a physical obstruction.

### Example B—Network Optimization in Densely Populated Areas

In environments with many wireless access points, such as in office buildings or multi-dwelling units (MDUs), a network administrator may use evaluation system 500 to evaluate and optimize an RF environment. For example, the network administrator may use state 534 information received via signal 604 to identify areas with dense RF interference. The network administrator may then use this information to guide adjustments in channel planning or power settings, thereby reducing co-channel interference and improving overall network performance.

### Example C—Satellite Communication (Satcom) Optimization

Evaluation system 500 may be used to optimize and monitor performance of ground station antennas in a satellite communication network. Satellite ground stations often face challenges such as varying levels of RF interference and physical obstructions, such as buildings, terrain, or weather, that can affect signal quality. State 534 determined by evaluation system 500 may be used to dynamically adjust the alignment of satellite antennas. For example, a ground station antenna may automatically adjust its antenna orientation or operating frequency, in response to receiving signal 604 indicating that the ground station antenna is subject to a dense RF environment, to mitigate potential interference from the dense RF environment.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method for evaluating a wireless communication path, the wireless communication path being between a first radio frequency (RF) node and a second RF node, the method comprising:
collecting a plurality of noise measurements over a sample time window from one or more of the first RF node and the second RF node, each noise measurement representing noise of the wireless communication path at a different respective time during the sample time window;
determining a representative value of the plurality of noise measurements;
determining a temporal variability value of the plurality of noise measurements;
performing a first comparison by comparing the representative value of the plurality of noise measurements to a predetermined noise threshold value;
performing a second comparison by comparing the temporal variability value of the plurality of noise measurements to a predetermined variation threshold value; and
determining a state of the wireless communication path based on each of the first comparison and the second comparison.

2. The method of claim 1, wherein the representative value of the plurality of noise measurements is a mean of the plurality of noise measurements.

3. The method of claim 1, wherein the temporal variability value of the plurality of noise measurements is a coefficient of variation of the plurality of noise measurements.

4. The method of claim 1, wherein the determined state of the wireless communication path is one of the following: (i) the wireless communication path is subject to a dense RF environment, (ii) the wireless communication path is physically obstructed, (iii) the wireless communication path possesses a clear line-of-sight, and (iv) the wireless communication path is subject to intermittent RF activity.

5. The method of claim 1, wherein determining the state of the wireless communication path based on each of the first comparison and the second comparison comprises determining that the wireless communication path is subject to a dense RF environment in response to (i) the first comparison indicating that the representative value of the plurality of noise measurements is at least the predetermined noise threshold value and (ii) the second comparison indicating that the temporal variability value of the plurality of noise measurements is at least the predetermined variation threshold value.

6. The method of claim 5, further comprising, in response to determining that the wireless communication path is subject to the dense RF environment, generating a control signal changing one or more of (i) a wireless transmission power of one or more of the first RF node and the second RF node, (ii) a wireless transmission channel of one or more of the first RF node and the second RF node, and (iii) a modulation coding scheme of one or more of the first RF node and the second RF node.

7. The method of claim 1, wherein determining the state of the wireless communication path based on each of the first comparison and the second comparison comprises determining that the wireless communication path is physically obstructed in response to (i) the first comparison indicating that the representative value of the plurality of noise measurements is at least the predetermined noise threshold value and (ii) the second comparison indicating that the temporal variability value of the plurality of noise measurements is less than the predetermined variation threshold value.

8. The method of claim 7, further comprising, in response to determining that the wireless communication path is physically obstructed, generating a control signal for adjusting an antenna orientation of one or more of the first RF node and the second RF node.

9. The method of claim 1, wherein determining the state of the wireless communication path based on each of the first comparison and the second comparison comprises determining that the wireless communication path possesses a clear line-of-sight in response to (i) the first comparison indicating that the representative value of the plurality of noise measurements is less than the predetermined noise threshold value and (ii) the second comparison indicating that the temporal variability value of the plurality of noise measurements is less than the predetermined variation threshold value.

10. The method of claim 1, wherein determining the state of the wireless communication path based on each of the first comparison and the second comparison comprises determining that the wireless communication path is subject to intermittent RF activity in response to (i) the first comparison indicating that the representative value of the plurality of noise measurements is less than the predetermined noise threshold value and (ii) the second comparison indicating that the temporal variability value of the plurality of noise measurements is at least the predetermined variation threshold value.

11. The method of claim 1, wherein:
the first RF node is a wireless access point operating according to an Institute of Electrical and Electronics Engineers (IEEE) 802.11 wireless communication protocol; and
the second RF node is a station operating according to an IEEE 802.11 wireless communication protocol.

12. The method of claim 1, further comprising changing operation of one or more of the first RF node and the second RF node based on the determined state of the wireless communication path.

13. A method for evaluating a wireless communication path, the wireless communication path being between a first radio frequency (RF) node and a second RF node, the method comprising:
collecting a plurality of noise measurements over a sample time window from one or more of the first RF node and the second RF node, each noise measurement representing noise of the wireless communication path at a different respective time during the sample time window;
determining a representative value of the plurality of noise measurements;
determining a temporal variability value of the plurality of noise measurements; and
determining, from the representative value of the plurality of noise measurements and the temporal variability value of the plurality of noise measurements, that the wireless communication path is physically obstructed in response to (i) the representative value of the plurality of noise measurements being at least a predetermined noise threshold value and (ii) the temporal variability value of the plurality of noise measurements being less than a predetermined variation threshold value.

14. The method of claim 13, wherein:
the representative value of the plurality of noise measurements is a mean of the plurality of noise measurements; and
the temporal variability value of the plurality of noise measurements is a coefficient of variation of the plurality of noise measurements.

15. The method of claim 13, wherein:
the first RF node is a wireless access point operating according to an Institute of Electrical and Electronics Engineers (IEEE) 802.11 wireless communication protocol; and
the second RF node is a station operating according to an IEEE 802.11 wireless communication protocol.

16. The method of claim 13, further comprising, in response to determining that the wireless communication path is physically obstructed, generating a control signal for adjusting an antenna orientation of one or more of the first RF node and the second RF node.

17. A method for evaluating a wireless communication path, the wireless communication path being between a first radio frequency (RF) node and a second RF node, the method comprising:
collecting a plurality of noise measurements over a sample time window from one or more of the first RF node and the second RF node, each noise measurement representing noise of the wireless communication path at a different respective time during the sample time window;
determining a representative value of the plurality of noise measurements;
determining a temporal variability value of the plurality of noise measurements; and
determining, from the representative value of the plurality of noise measurements and the temporal variability value of the plurality of noise measurements, that the wireless communication path is subject to a dense RF environment in response to (i) the representative value of the plurality of noise measurements being at least a predetermined noise threshold value and (ii) the temporal variability value of the plurality of noise measurements being at least a predetermined variation threshold value.

18. The method of claim 17, wherein:
the representative value of the plurality of noise measurements is a mean of the plurality of noise measurements; and
the temporal variability value of the plurality of noise measurements is a coefficient of variation of the plurality of noise measurements.

19. The method of claim 17, wherein:
the first RF node is a wireless access point operating according to an Institute of Electrical and Electronics Engineers (IEEE) 802.11 wireless communication protocol; and
the second RF node is a station operating according to an IEEE 802.11 wireless communication protocol.

20. The method of claim 17, further comprising, in response to determining that the wireless communication path is subject to the dense RF environment, generating a control signal changing one or more of (i) a wireless transmission power of one or more of the first RF node and the second RF node, (ii) a wireless transmission channel of one or more of the first RF node and the second RF node, and (iii) a modulation coding scheme of one or more of the first RF node and the second RF node.
